(19) United States
(12) Patent Application Publication
(10) Pub. No.: US 2021/0135181 A1
(43) Pub. Date: May 6, 2021

(54) SECONDARY BATTERY

(71) Applicant: SAMSUNG SDI CO., LTD., Yongin-si (KR)

(72) Inventor: Mi Ae UM, Yongin-si (KR)

(21) Appl. No.: 17/037,211

(22) Filed: Sep. 29, 2020

(30) Foreign Application Priority Data
Oct. 31, 2019 (KR) 10-2019-0138091

(51) Int. Cl. H01M 2/26; H01M 2/02; H01M 10/42

(52) U.S. Cl. CPC H01M 2/266; H01M 2200/00; H01M 10/425; H01M 2/02

(57) ABSTRACT

Embodiments of the present disclosure relate to a secondary battery capable of reducing a probability of damage occurring to components associated with a safety device. According to an embodiment, a secondary battery includes: a bare cell including an electrode tab outwardly extending; a connection tab comprising a first region coupled to the electrode tab and a second region extending from the first region and folded along a boundary line between the first region and the second region, and including a slot provided on the boundary line, a distance between the slot and a first edge of the connection tab intersecting the boundary line being smaller than a distance between the slot and a second edge of the connection tab opposite the first edge; and a safety device adjacent to the first edge of the connection tab and electrically connected to the connection tab.

### CROSS-REFERENCE TO RELATED APPLICATION

This application claims priority to and the benefit of Korean Patent Application No. 10-2019-0138091, filed on Oct. 31, 2019 in the Korean Intellectual Property Office, the entire content of which is herein incorporated by reference.

### BACKGROUND

### 1. Field

Aspects of embodiments of the present disclosure relate to a secondary battery.

### 2. Description of the Related Art

Unlike primary batteries, which are not rechargeable, secondary batteries can be charged and discharged. Low-capacity secondary batteries may be used in portable small-sized electronic devices, e.g., a smartphone, a laptop computer, a digital camera, a camcorder, and the like, and high-capacity secondary batteries are extensively used as an energy source, e.g., for driving a motor for a hybrid vehicle, an electric vehicle, a power storage cell, and the like.

The secondary battery can be classified into, e.g., a cylindrical type, a prismatic type, a pouch type, and so on, according to the external shape of the battery. Among others, the pouch type secondary battery includes an electrode assembly, a pouch accommodating the electrode assembly and an electrolytic solution, and electrode tabs extending from the electrode assembly to the exterior of the pouch. In addition, the pouch type secondary battery may include a safety device for automatically interrupting electric current due to rapidly increasing resistance when the internal temperature exceeds a preset level.

The above information disclosed in this Background section is only for enhancement of understanding of the background of the described technology and, therefore, it may contain information that does not form the prior art that is already known in this country to a person of ordinary skill in the art.

### SUMMARY

According to aspects of embodiments of the present disclosure, a secondary battery capable of reducing a probability of damage occurring to components associated with a safety device is provided.

According to one or more embodiments of the present disclosure, a secondary battery includes: a bare cell including an electrode tab outwardly extending; a connection tab comprising a first region coupled to the electrode tab and a second region extending from the first region and folded along a boundary line between the first region and the second region, and including a slot provided on the boundary line, wherein a distance between the slot and a first edge of the connection tab intersecting the boundary line is smaller than a distance between the slot and a second edge of the connection tab opposite the first edge; and a safety device adjacent to the first edge of the connection tab and electrically connected to the connection tab.

In an embodiment, a length of the slot may be larger than the distance between the slot and the first edge of the connection tab.

In an embodiment, a length of the slot may be smaller than the distance between the slot and the second edge of the connection tab.

In an embodiment, a ratio defined as the distance between the slot and the first edge of the connection tab:a length of the slot:the distance between the slot and the second edge of the connection tab is 1:2 to 2.5:2.5 to 3.

In an embodiment, the distance between the slot and the first edge of the connection tab may be 1.5 mm or greater.

In an embodiment, the secondary battery may further include a printed circuit board on which the connection tab and the safety device are installed.

In an embodiment, the boundary line extends in a same direction in which the electrode tab outwardly extends.

In an embodiment, the second edge of the connection tab is spaced from the first edge of the connection tab in the direction in which the electrode tab outwardly extends.

In an embodiment, the boundary line extends in a direction crossing a direction in which the electrode tab outwardly extends.

In an embodiment, the connection tab further includes a third region extending from the first region and folded along another boundary line between the first region and the third region.

In an embodiment, the third region is folded so as to overlap the first region.

In an embodiment, the boundary line extends in a direction crossing a direction in which the electrode tab outwardly extends, and the another boundary line extends in the direction in which the electrode tab outwardly extends.

As described above, in a secondary battery according to one or more embodiments of the present disclosure, when a connection tab is partially folded for fixedly coupling the connection tab, a slot is provided on a folding line so as to allow a portion of the connection tab close to a safety device to start to be folded, and thus an end of the portion of the connection tab naturally faces the safety device from a distance. Accordingly, a probability of the end of the portion of the connection tab being interfered with by the safety device may be reduced.

### BRIEF DESCRIPTION OF DRAWINGS

FIGS. 1 to 3 illustrate a process of coupling a protection module to a bare cell in a secondary battery according to an embodiment.

FIG. 4 is an enlarged view illustrating a region “A” of FIG. 2.

FIG. 5 illustrates a state in which a protective circuit board is coupled to a bare cell in a secondary battery according to another embodiment.

### DETAILED DESCRIPTION

Herein, some example embodiments of the present disclosure will be described in further detail with reference to the accompanying drawings.

The subject matter of the present disclosure, however, may be embodied in many different forms and should not be construed as being limited to the example embodiments set forth herein. Rather, these example embodiments are provided so that this disclosure will be thorough and complete and will convey the aspects and features of the present disclosure to those skilled in the art.

In addition, in the accompanying drawings, sizes or thicknesses of various components may be exaggerated for brevity and clarity. Like numbers refer to like elements throughout. As used herein, the term “and/or” includes any and all combinations of one or more of the associated listed items. In addition, it will be understood that when an element A is referred to as being “connected to” an element B, the element A may be directly connected to the element B or one or more intervening elements C may be present therebetween such that the element A and the element B are indirectly connected to each other.

The terminology used herein is for the purpose of describing particular embodiments and is not intended to be limiting of the disclosure. As used herein, the singular forms are intended to include the plural forms as well, unless the context clearly indicates otherwise.

It is to be further understood that the terms “comprise” or “include” and/or “comprising” or “including,” (“comprise,” “comprising,” “include,” “including,”) and/or “has,” and variations thereof, when used in this specification, specify the presence of stated features, numbers, steps, operations, elements, and/or components, but do not preclude the presence or addition of one or more other features, numbers, steps, operations, elements, components, and/or groups thereof.

It is to be understood that, although the terms “first,” “second,” etc. may be used herein to describe various members, elements, regions, layers, and/or sections, these members, elements, regions, layers, and/or sections should not be limited by these terms. These terms are used to distinguish one member, element, region, layer, and/or section from another. Thus, for example, a first member, a first element, a first region, a first layer, and/or a first section discussed below could be termed a second member, a second element, a second region, a second layer, and/or a second section without departing from the teachings of the present disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the element in the figures is turned over, elements described as “below” or “beneath” other elements or features would then be oriented “on” or “above” the other elements or features. Thus, the example term “below” can encompass both an orientation of above and below.

Unless otherwise defined, all terms (including technical and scientific terms) used herein have the same meaning as commonly understood by one of ordinary skill in the art to which the inventive concept pertains. It is also to be understood that terms defined in commonly used dictionaries should be interpreted as having meanings consistent with the meanings in the context of the related art, and are expressly defined herein unless they are interpreted in an ideal or overly formal sense.

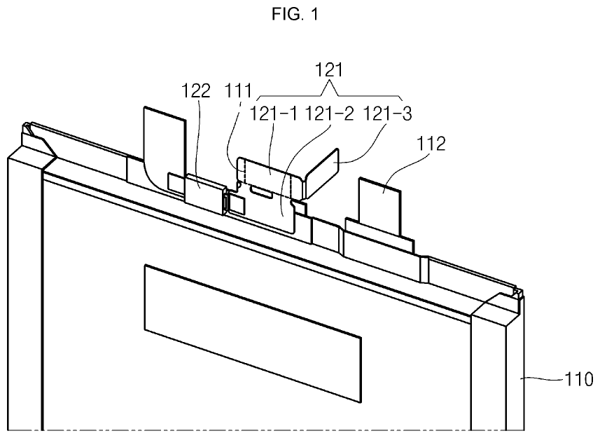

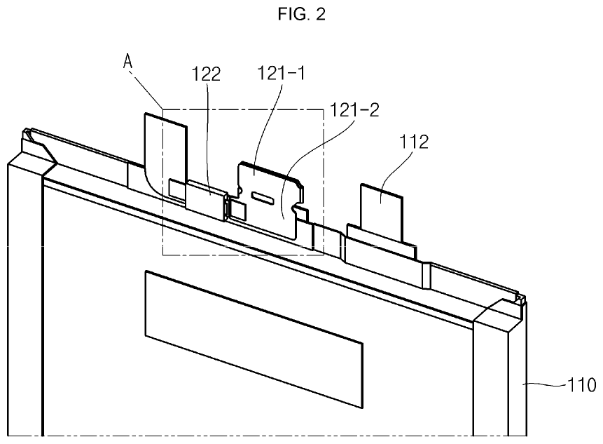

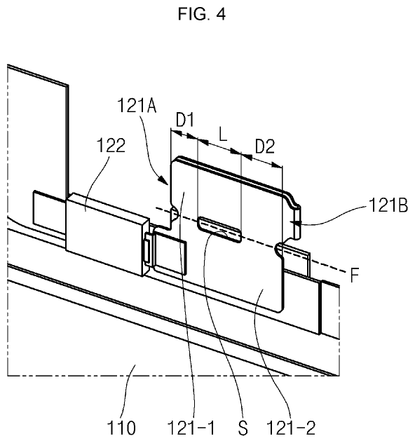

FIGS. 1 to 3 illustrate a process of coupling a protection module to a bare cell in a secondary battery according to an embodiment; and FIG. 4 is an enlarged view illustrating a region “A” of FIG. 2.

Referring to FIGS. 1 to 3, a secondary battery according to an embodiment includes a bare cell 110 and a protection module.

The bare cell 110 includes an electrode assembly including a first electrode plate (e.g., a positive electrode plate), a second electrode plate (e.g., a negative electrode plate), and a separator interposed between the first electrode plate and the second electrode plate, a pouch covering the electrode assembly, a first electrode tab 111 extending from the first electrode plate to the exterior of the pouch, and a second electrode tab 112 extending from the second electrode plate to the exterior of the pouch.

The protection module includes a connection tab 121 and a safety device 122.

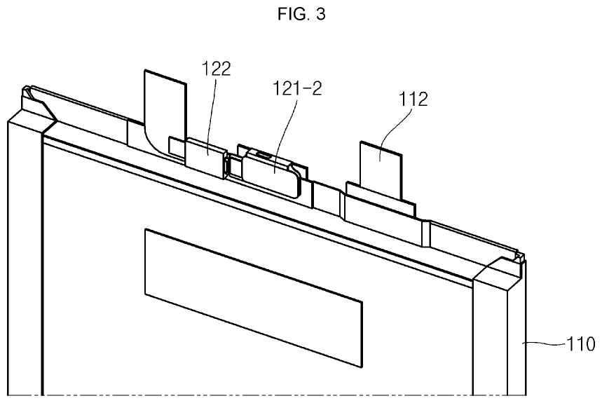

The connection tab 121 is made of a conductive material, such as nickel. In an embodiment, the connection tab 121 may include a first region 121-1 to be coupled to a first surface of the first electrode tab 111, a second region 121-2 extending from the first region 121-1 in a direction opposite to the direction in which the first electrode tab 111 extends, and a third region 121-3 extending from the first region 121-1 across the direction in which the first electrode tab 111 extends. In an embodiment, the first region 121-1 is welded to the first surface of the first electrode tab 111, as shown in FIG. 1, the third region 121-3 is folded over relative to the first region 121-1 to cover a second surface of the first electrode tab 111 that is opposite the first surface, as shown in FIG. 2, and the first region 121-1 and the third region 121-3 are folded over relative to the second region 121-2, as shown in FIG. 3.

In an embodiment, the connection tab 121 may be configured in such a manner that the second region 121-2 extends from the first region 121-1 across the direction in which the first electrode tab 111 extends, the third region 121-3 extends from the first region 121-1 in the direction in which the first electrode tab 111 extends, or in another suitable manner. For a better understanding of the present disclosure, the following description will be made with regard to a case in which the connection tab 121 is configured as shown in the drawings.

In an embodiment, the safety device 122 may be a thermal cut-off (TCO). If the temperature of the bare cell 110 exceeds a certain level (e.g., a preset level), the safety device 122 automatically interrupts electric current, thereby preventing or substantially preventing the bare cell 110 from being overheated. In an embodiment, the safety device 122 is disposed to be adjacent to an edge meeting a folding line F between the first region 121-1 and the second region 121-2 of the connection tab 121 to then be electrically connected to the connection tab 121.

In this case, if the connection tab 121 is inaccurately folded along a boundary line between the first region 121-1 and the second region 121-2, that is, the folding line F, such as due to an operator's inadvertence in the course of folding the first region 121-1 relative to the second region 121-2, the first region 121-1 may be interfered with by the safety device 122, resulting in damage caused to related components.

To avoid this, the secondary battery according to an embodiment includes a slot S provided on the folding line F of the connection tab 121. The slot S will be described below in further detail with reference to FIG. 4.

Referring to FIG. 4, the slot S is provided on the folding line F between the first region 121-1 and the second region 121-2.

Here, the slot S is disposed to be biased to a first edge 121A of the connection tab 121 meeting the folding line F. In other words, a distance D1 between the first edge 121A of the connection tab 121 and the slot S is smaller than a distance D2 between an opposite second edge 121B and the slot S.

With this configuration, when the first region 121-1 is folded relative to the second region 121-2, the first edge 121A of the connection tab 121 may be easily folded by a smaller force than the other edge 121B. Therefore, the first edge 121A of the connection tab 121 may start to be folded first, and the second edge 121B may then be folded. When the first edge 121A of the connection tab 121 starts to be folded first, the end of the first region 121-1 naturally tends to face toward the second edge 121B of the connection tab 121, and, thus, the end of the first region 121-1 may be slantingly folded so as to face the first edge 121A of the connection tab 121, thereby reducing the probability of being interfered with by the safety device 122.

In an embodiment, a length L of the slot S may be larger than the distance D1 between the first edge 121A of the connection tab 121 and the slot S. However, the length L of the slot S may be smaller than the distance D2 between the second edge 121B of the connection tab 121 and the slot S.

In an embodiment, a ratio defined as the distance D1 between the first edge 121A of the first region 121-1 and the slot S:the length L of the slot S:the distance D2 between the second edge 121B of the first region 121-1 and the slot S may be 1:2 to 2.5:2.5 to 3. In an embodiment, the ratio defined as the distance D1 between the first edge 121A of the first region 121-1 and the slot S:the length L of the slot S:the distance D2 between the second edge 121B of the first region 121-1 and the slot S may be 1:2:2.5.

Accordingly, an effect exerted when the first edge 121A of the connection tab 121 starts to be folded first may be more securely ensured.

In an embodiment, the distance D1 between the first edge 121A of the first region 121-1 and the slot S may be 1.5 mm or greater.

Hence, electric current may be smoothly conducted between the first edge 121A of the first region 121-1 and the slot S.

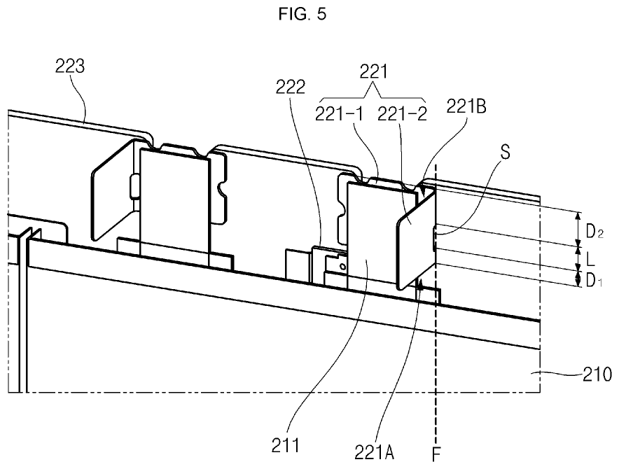

FIG. 5 illustrates a state in which a protective circuit board is coupled to a bare cell 210 in a secondary battery according to another embodiment.

In the illustrated embodiment, the bare cell 210 may be substantially the same as the bare cell 110 of the previously described embodiment. Differences between the bare cell 110 and the bare cell 210, if any, may merely amount to changes which could be made by one skilled in the art, such as employing a printed circuit board, instead of a protection module, and thus a repeated description thereof will be omitted.

In an embodiment, the printed circuit board includes a connection tab 221, a safety device 222, and a board 223 on which the connection tab 221 and the safety device 222 are installed.

The connection tab 221 may include a first region 221-1 fixed to the board 223 to be coupled to a surface of a first electrode tab 211, and a second region 221-2 extending from the first region 221-1. In an embodiment, the first region 221-1 may be welded to a first surface of the first electrode tab 211, and the second region 221-2 may be folded over relative to the first region 221-1 to cover an opposite second surface of the first electrode tab 211.

In an embodiment, the safety device 222 may be a TCO. In an embodiment, the safety device 222 is disposed to be adjacent to a first edge 221A of the connection tab 221 meeting a folding line F between the first region 221-1 and the second region 221-2 of the connection tab 221 to then be electrically connected to the first region 221-1 through the board 223.

Like in the previously described embodiment, the slot S is provided on the folding line F.

Here, the slot S is disposed to be biased to the first edge 221A of the connection tab 221. In other words, a distance D₁ between the first edge 221A of the connection tab 221 and the slot S is smaller than a distance D2 between an opposite second edge 221B and the slot S.

In an embodiment, a length L of the slot S may be larger than the distance D₁ between the first edge 221A of the connection tab 221 and the slot S and smaller than the distance D2 between the second edge 221B and the slot S.

In an embodiment, a ratio defined as the distance D₁ between the first edge 221A of the connection tab 221 and the slot S:the length L of the slot S:the distance D2 between the second edge 221B of the connection tab 221 and the slot S may be 1:2 to 2.5:2.5 to 3. In an embodiment, the ratio defined as the distance D₁ between the first edge 221A of the connection tab 221 and the slot S:the length L of the slot S:the distance D2 between the second edge 221B of the connection tab 221 and the slot S may be 1:2:2.5.

In an embodiment, the distance D₁ between the first edge 221A of the first region 221-1 and the slot S may be 1.5 mm or greater.

While one or more example embodiments have been described to practice the secondary battery of the present disclosure, it will be understood by those of ordinary skill in the art that various changes in form and details may be made therein without departing from the spirit and scope of the present disclosure as set forth by the following claims.

What is claimed is:

1. A secondary battery comprising:
a bare cell comprising an electrode tab outwardly extending;
a connection tab comprising a first region coupled to the electrode tab and a second region extending from the first region and folded along a boundary line between the first region and the second region, and including a slot provided on the boundary line, wherein a distance between the slot and a first edge of the connection tab intersecting the boundary line is smaller than a distance between the slot and a second edge of the connection tab opposite the first edge; and
a safety device adjacent to the first edge of the connection tab and electrically connected to the connection tab.

2. The secondary battery of claim 1, wherein a length of the slot is larger than the distance between the slot and the first edge of the connection tab.

3. The secondary battery of claim 1, wherein a length of the slot is smaller than the distance between the slot and the second edge of the connection tab.

4. The secondary battery of claim 1, wherein a ratio defined as the distance between the slot and the first edge of the connection tab:a length of the slot:the distance between the slot and the second edge of the connection tab is 1:2 to 2.5:2.5 to 3.

5. The secondary battery of claim 1, wherein the distance between the slot and the first edge of the connection tab is 1.5 mm or greater.

6. The secondary battery of claim 1, further comprising a printed circuit board on which the connection tab and the safety device are installed.

7. The secondary battery of claim 6, wherein the boundary line extends in a same direction in which the electrode tab outwardly extends.

8. The secondary battery of claim 7, wherein the second edge of the connection tab is spaced from the first edge of the connection tab in the direction in which the electrode tab outwardly extends.

9. The secondary battery of claim 1, wherein the boundary line extends in a direction crossing a direction in which the electrode tab outwardly extends.

10. The secondary battery of claim 1, wherein the connection tab further comprises a third region extending from the first region and folded along another boundary line between the first region and the third region.

11. The secondary battery of claim 10, wherein the third region is folded so as to overlap the first region.

12. The secondary battery of claim 10, wherein the boundary line extends in a direction crossing a direction in which the electrode tab outwardly extends, and the another boundary line extends in the direction in which the electrode tab outwardly extends.
